(19) United States
(12) Patent Application Publication
(10) Pub. No.: US 2022/0213775 A1
(43) Pub. Date: Jul. 7, 2022

(54) DETERMINING COMPOSITE MATRIX-FRACTURE PROPERTIES OF NATURALLY FRACTURED RESERVOIRS IN NUMERICAL RESERVOIR SIMULATION

(71) Applicant: Saudi Arabian Oil Company, Dhahran (SA)

(72) Inventors: Babatope Kayode, Dhahran (SA); Abdulaziz Suwailem, Khobar (SA)

(21) Appl. No.: 17/140,327

(22) Filed: Jan. 4, 2021

(51) Int. Cl. E21B 43/267; E21B 47/003; E21B 47/12; G01V 1/46; G01V 1/48

(52) U.S. Cl. CPC E21B 43/267; E21B 47/003; G01V 1/48; G01V 1/46; E21B 47/12

(57) ABSTRACT

Methods for determining composite matrix-fracture properties of naturally fractured reservoirs include obtaining, by a computer system, measured hydrocarbon data from one or more hydrocarbon wells using one or more formation evaluation tools. The computer system generates composite matrix-fracture properties of the one or more hydrocarbon wells using numerical simulation. The composite matrix-fracture properties include at least one of composite matrix-fracture permeability, composite matrix-fracture water saturation, composite matrix-fracture pressure, or composite matrix-fracture mobility of the one or more hydrocarbon wells. The computer system performs history matching for the one or more hydrocarbon wells by comparing the measured hydrocarbon data to the composite matrix-fracture properties. A display device of the computer system generates a graphical representation of results of the history matching.

### TECHNICAL FIELD

This description relates generally to hydrocarbon reservoirs, for example, to determining composite matrix-fracture properties of naturally fractured reservoirs in numerical reservoir simulation.

### BACKGROUND

Hydrocarbon reservoir modeling and simulation can pose several challenges. Fractures occur as visible structural features in the Earth's upper crust. Fractures can be apparent at most rock ridges. Many hydrocarbon reservoirs contain natural fractures. However, traditional simulation methods are unable to effectively history match measured data sets from naturally fractured reservoirs because of deficiencies in logs obtained from simulation.

### SUMMARY

Methods for determining composite matrix-fracture properties of naturally fractured reservoirs in numerical reservoir simulation include obtaining, by a computer system, measured hydrocarbon data from one or more hydrocarbon wells using one or more formation evaluation tools. The computer system generates composite matrix-fracture properties of the one or more hydrocarbon wells using numerical simulation. The composite matrix-fracture properties include at least one of composite matrix-fracture permeability, composite matrix-fracture water saturation, composite matrix-fracture pressure, or composite matrix-fracture mobility of the one or more hydrocarbon wells. The computer system performs history matching for the one or more hydrocarbon wells by comparing the measured hydrocarbon data to the composite matrix-fracture properties. A display device of the computer system generates a graphical representation of results of the history matching.

In some implementations, generating the composite matrix-fracture properties includes obtaining, by the computer system, a first grid and a second grid representing the one or more hydrocarbon wells. The first grid includes matrix properties of the one or more hydrocarbon wells and the second grid includes fracture properties of the one or more hydrocarbon wells. The numerical simulation is based on the first grid and the second grid.

In some implementations, the one or more formation evaluation tools include at least a Modular Dynamics Tester (MDT) pressure-mobility probe.

In some implementations, the computer system calibrates a first transmissivity of a fracture model of the one or more hydrocarbon wells based on a second transmissivity obtained from pressure transient analysis (PTA). The calibrating uses the composite matrix-fracture permeability. The measured hydrocarbon data includes the second transmissivity.

In some implementations, the measured hydrocarbon data includes measured Pulsed Neutron Log (PNL) data. The history matching includes comparing the measured PNL data to the composite matrix-fracture water saturation.

In some implementations, the measured hydrocarbon data includes measured MDT data. The history matching comprises comparing the measured MDT data to the composite matrix-fracture pressure.

In some implementations, the measured hydrocarbon data includes measured mobility data. The history matching includes comparing the measured mobility data to the composite matrix-fracture mobility.

### BRIEF DESCRIPTION OF THE DRAWINGS

FIG. 1 illustrates an example of the Dual Porosity Dual Permeability (DPDP) approach for incorporating natural fractures into geologic models, in accordance with one or more implementations.

FIG. 2A illustrates an example matrix and an example natural fracture, in accordance with one or more implementations.

FIG. 2B illustrates example fluid flow through a fracture, in accordance with one or more implementations.

FIG. 2C illustrates an example Modular Dynamics Tester (MDT) pressure-mobility probe, in accordance with one or more implementations.

FIGS. 3A-3B illustrate an example numerical simulation, in accordance with one or more implementations.

FIGS. 4A-4C illustrate an example numerical simulation, in accordance with one or more implementations.

FIGS. 5A-5D illustrate example MDT and Pulsed Neutron Log (PNL) output from numerical simulation, in accordance with one or more implementations.

FIG. 6 illustrates a process for determining composite matrix-fracture properties of naturally fractured reservoirs in numerical reservoir simulation, in accordance with one or more implementations.

FIGS. 7A-7B illustrate a graphical representation of a flow rate against elapsed time, in accordance with one or more implementations.

FIGS. 8A-8D illustrate examples of numerical well testing for different fracture models, in accordance with one or more implementations.

FIG. 9 illustrates example PNL history matching, in accordance with one or more implementations.

FIG. 10 illustrates example MDT history matching, in accordance with one or more implementations.

FIG. 11 illustrates example mobility history matching, in accordance with one or more implementations.

FIG. 12 illustrates example PTA-kh history matching, in accordance with one or more implementations.

FIG. 13 illustrates example PTA-kh history matching, in accordance with one or more implementations.

FIG. 14 illustrates example mobility history matching, in accordance with one or more implementations.

FIG. 15 illustrates example PNL history matching, in accordance with one or more implementations.

FIG. 16 illustrates example MDT history matching, in accordance with one or more implementations.

FIG. 17 illustrates experimental results for determining composite matrix-fracture properties of naturally fractured reservoirs in numerical reservoir simulation, in accordance with one or more implementations.

FIG. 18 illustrates an example computer system, in accordance with one or more implementations.

### DETAILED DESCRIPTION

The implementations disclosed provide methods, apparatus, and systems for determining composite matrix-fracture properties of naturally fractured reservoirs in numerical reservoir simulation. Fractures occur as visible structural features in the Earth's upper crust. Fractures can be apparent at most rock ridges. Many hydrocarbon reservoirs contains natural fractures. Natural fractures can be caused by stress in the formation usually from tectonic forces such as folds and faults. Fractures occur in preferential directions, determined by the direction of regional stress. This is usually parallel to the direction of nearby faults or folds, but in the case of faults, they may be perpendicular to the fault or there may be two orthogonal directions. In the implementations disclosed, a computer system obtains measured hydrocarbon data from one or more hydrocarbon wells using one or more formation evaluation tools. The formation evaluation tools include at least a Modular Dynamics Tester (MDT) pressure-mobility probe. The computer system generates composite matrix-fracture properties of the one or more hydrocarbon wells using numerical simulation. The composite matrix-fracture properties include at least one of composite matrix-fracture permeability, composite matrix-fracture water saturation, composite matrix-fracture pressure, or composite matrix-fracture mobility of the one or more hydrocarbon wells. The computer system performs history matching for the one or more hydrocarbon wells by comparing the measured hydrocarbon data to the composite matrix-fracture properties. A display device of the computer system generates a graphical representation of results of the history matching.

Among other benefits and advantages, the methods provide a flexible and integrated framework for determining composite matrix-fracture properties of naturally fractured reservoirs in reservoir simulation. Unlike traditional methods that address only the implication of double porosity systems to pressure build-up, the implementations disclosed herein enable the determination of composite matrix-fracture properties in numerical simulation. The composite matrix-fracture permeability is also determined. Moreover, unlike traditional methods that address only the assumptions and equations for theoretical models of naturally fractured systems, the implementations disclosed herein perform history matching in naturally fractured reservoirs by determining composite matrix-fracture properties.

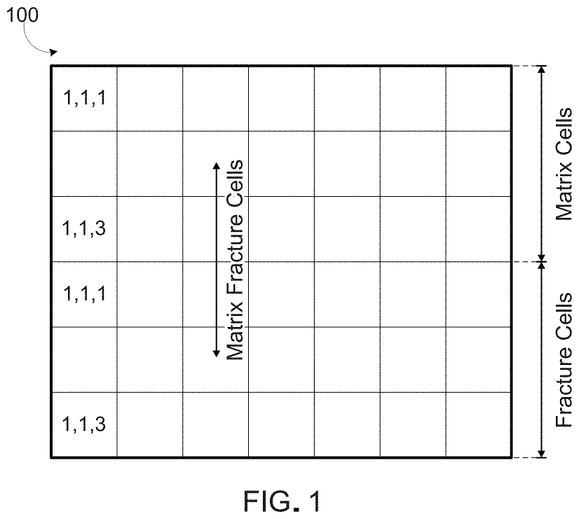

FIG. 1 illustrates an example of the Dual Porosity Dual Permeability (DPDP) approach for incorporating natural fractures into geologic models, in accordance with one or more implementations. Natural fractures are typically associated with increased oil or water productivity as well as increased vulnerability to contaminants. In some implementations, methods are developed for mmodeling fractured formations. For example, the DPDP approach uses Darcian flow through both matrix and fractures. Numerical simulation methods use the DPDP approach to incorporate natural fractures into geologic models.

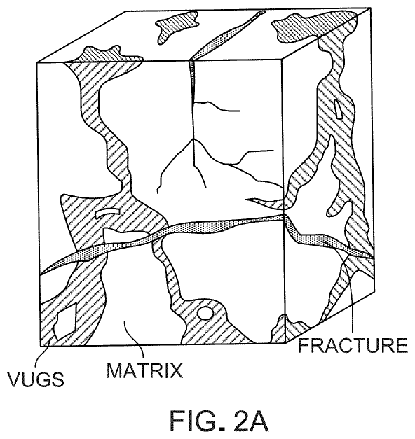

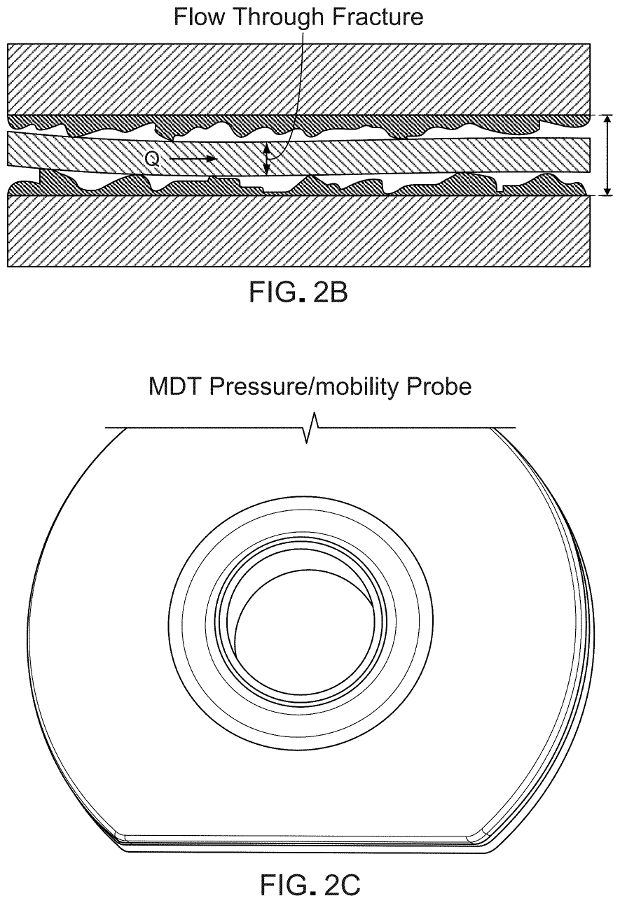

FIG. 2A illustrates an example matrix and an example natural fracture, in accordance with one or more implementations. The numerical simulation methods based on DPDP lead to different grids, each having identical dimensions and communicating with each other through a parameter denoted as sigma. For example, one grid is used for the matrix properties (porosity, permeability, and saturation) and a second grid for the fracture properties (porosity, permeability, and saturation).

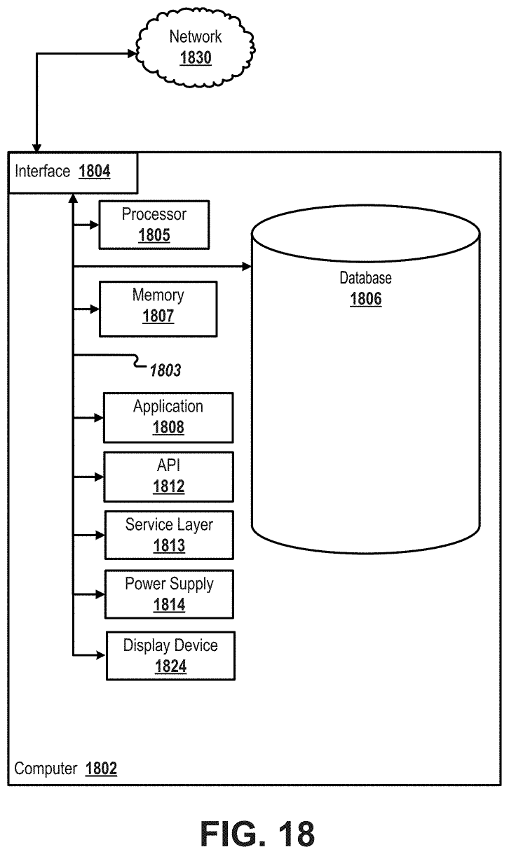

FIG. 2B illustrates example fluid flow through a fracture, in accordance with one or more implementations. Fluid flow occurs through the fractures, through the matrix, as well as through a matrix-fracture inter-flow. An example grid 100 using numerical simulation based on DPDP is shown in FIG. 1. In some implementations, a computer system solves fluid flow equations for the fracture grid and leads to results such as fracture water-saturation and fracture pressure at each time step. An example computer system is illustrated and described in more detail with reference to FIG. 18. At the same time, fluid flow equations are also solved for the matrix grid leading to results such as matrix water-saturation and matrix pressure at each time step. The simulated fracture grids and matrix grids results are reported as outputs of the numerical simulation. In naturally fractured reservoirs, the fracture opening (apertures) are small and are typically measured in microns, where 1 micron=10⁻⁶ meters (m). The formation evaluation tools have a vertical resolution in the order of inches. Because the vertical resolution of the formation evaluation tools is larger with respect to the fracture apertures, the formation evaluation tools are not used to merely measure the independent matrix and fracture properties in naturally fractured reservoirs. Instead, the formation evaluation tools are used to measure the composite (average) matrix-fracture property value. For example, a well-test involves initiating a flow-rate history on a hydrocarbon well and using a gauge to measure the associated wellbore pressure transients. The resulting pressure transient is representative of both the fracture and matrix properties within the tested interval.

FIG. 2C illustrates an example Modular Dynamics Tester (MDT) pressure-mobility probe, in accordance with one or more implementations. An MDT pressure-mobility probe can be used to measure and interpret the resulting pressure that reflects a combined matrix-fracture. An MDT pressure-mobility probe typically has a surface area of about 3 square inches, which is larger than the fracture apertures. Hence, the MDT pressure-mobility probe can be used to measure a composite matrix-fracture pressure. An MDT pressure-mobility probe used for MDT-mobility measurement is larger than fracture apertures. Hence, the MDT pressure-mobility probe cannot typically differentiate between mobility resulting from a fracture and mobility resulting from a matrix. Hence, the MDT pressure-mobility probe reflects the composite matrix-fracture mobility. In addition, Pulsed Neutron Log (PNL) tools have a vertical resolution of about 5-8 inches, which is several times larger than fracture apertures. Hence, PNL tools also measures the composite matrix-fracture water saturation.

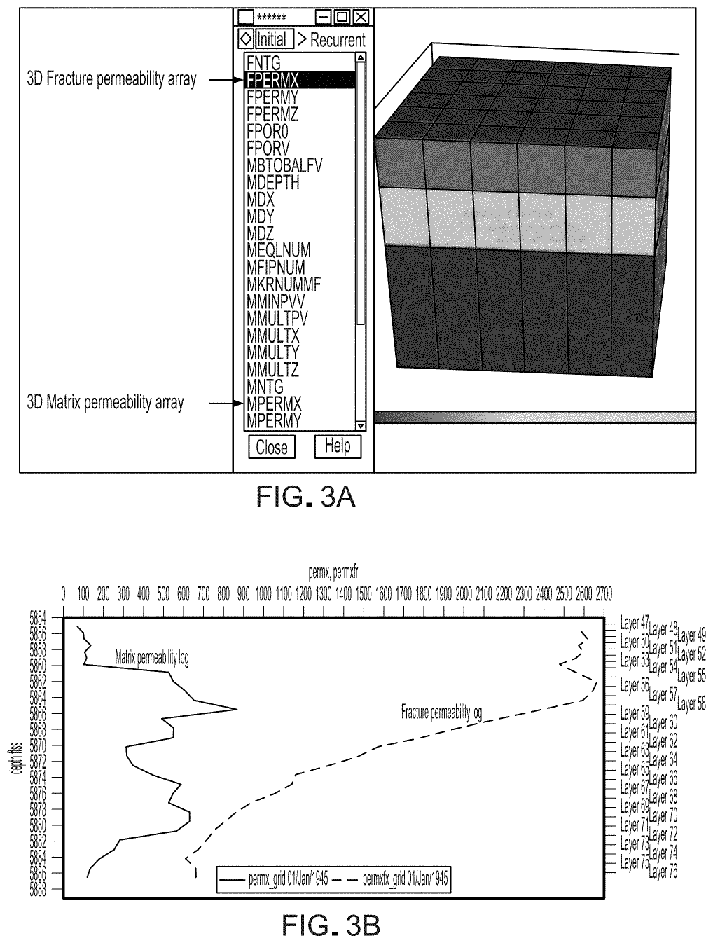

FIG. 3A illustrates an example numerical simulation, in accordance with one or more implementations. Three-dimensional (3D) output arrays provided for matrix and fracture permeability are shown in FIG. 3A. No output is generated for composite matrix-fracture permeability. FIG. 3B illustrates an example numerical simulation, in accordance with one or more implementations. The simulation outputs in FIG. 3B show the matrix and fracture permeability logs independently. No output log for the composite matrix-fracture permeability is generated. History matching refers to a process of comparing numerical simulation results to measured data. The simulator inputs are then modified if necessary until the simulator output matches the measured data. Thus, in order to history match measured data sets obtained from hydrocarbon wells or reservoirs, the numerical simulation is used to determine and output composite matrix-fracture properties to be compared with the measured data.

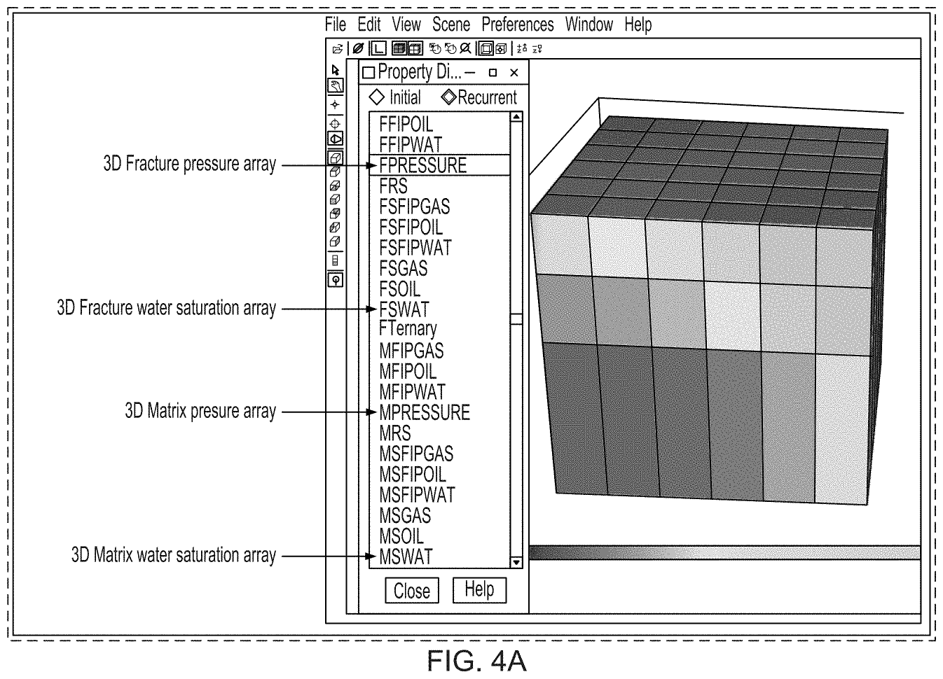

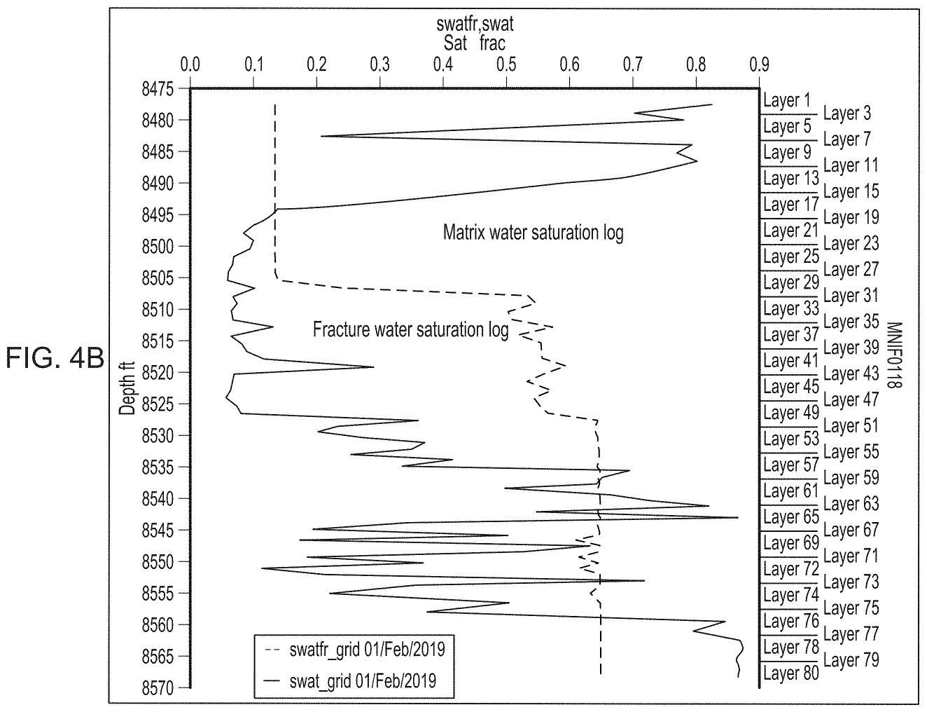

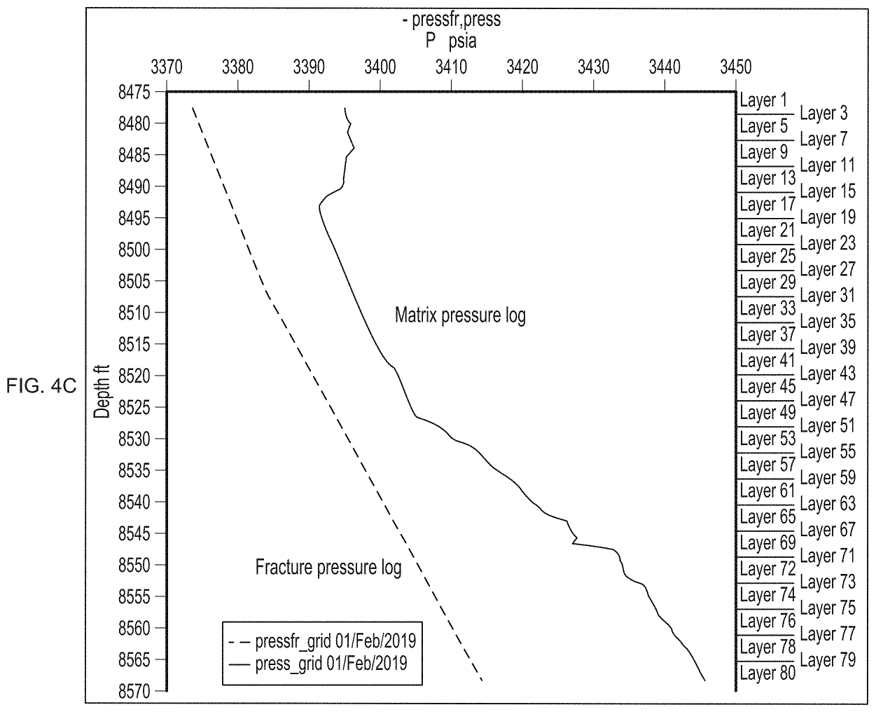

FIG. 4A illustrates an example numerical simulation, in accordance with one or more implementations. The example numerical simulation results shown in FIG. 4A displays 3D output arrays for the numerical matrix and fracture pressure as well as water saturation. No output is generated for the composite matrix-fracture pressure and water saturation. FIG. 4B illustrates an example numerical simulation, in accordance with one or more implementations. FIG. 4C illustrates an example numerical simulation, in accordance with one or more implementations. The matrix and fracture pressure and saturation log are shown independently in FIGS. 4B and 4C. No output log is provided for the composite matrix-fracture pressure or saturation.

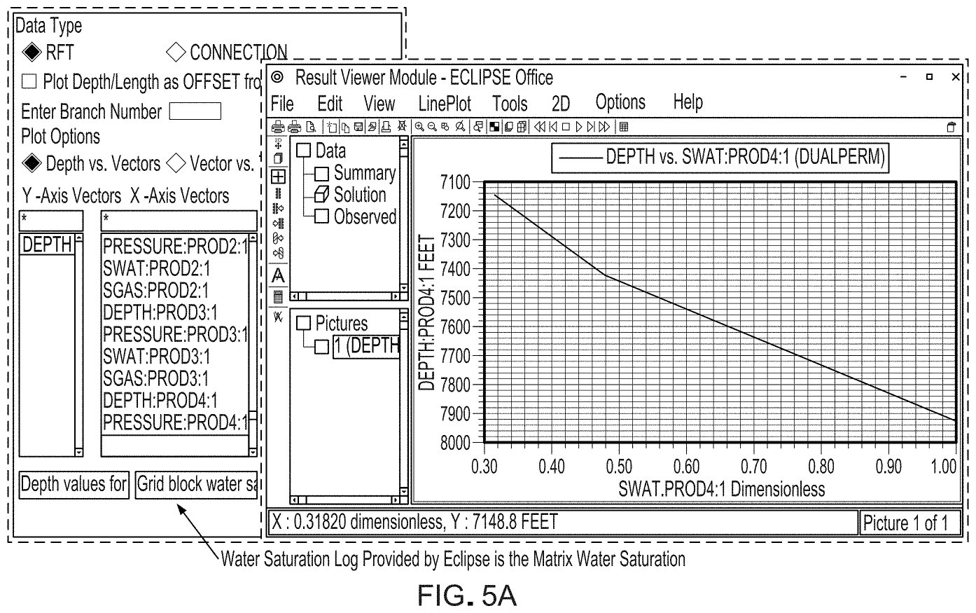

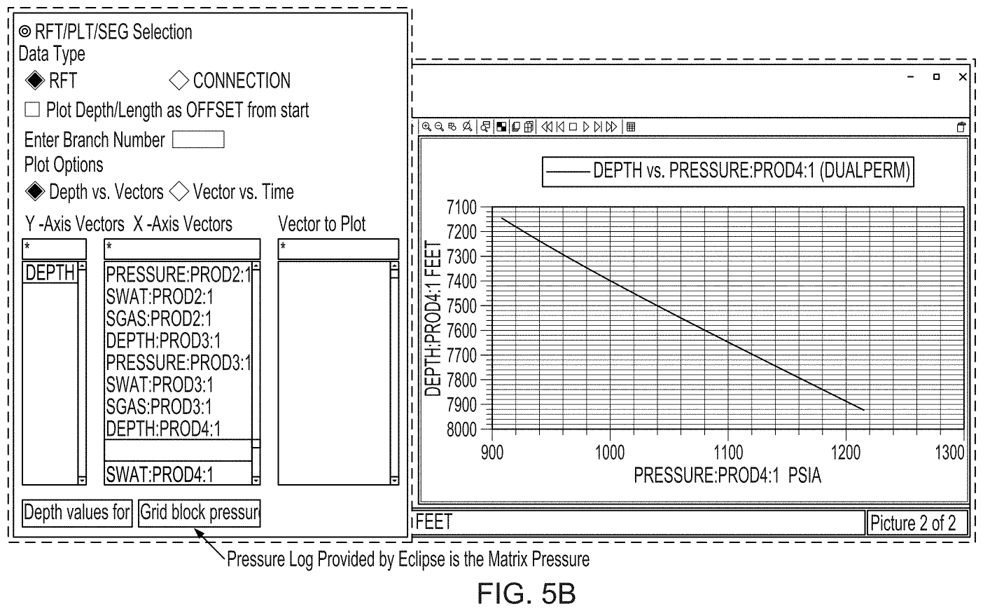

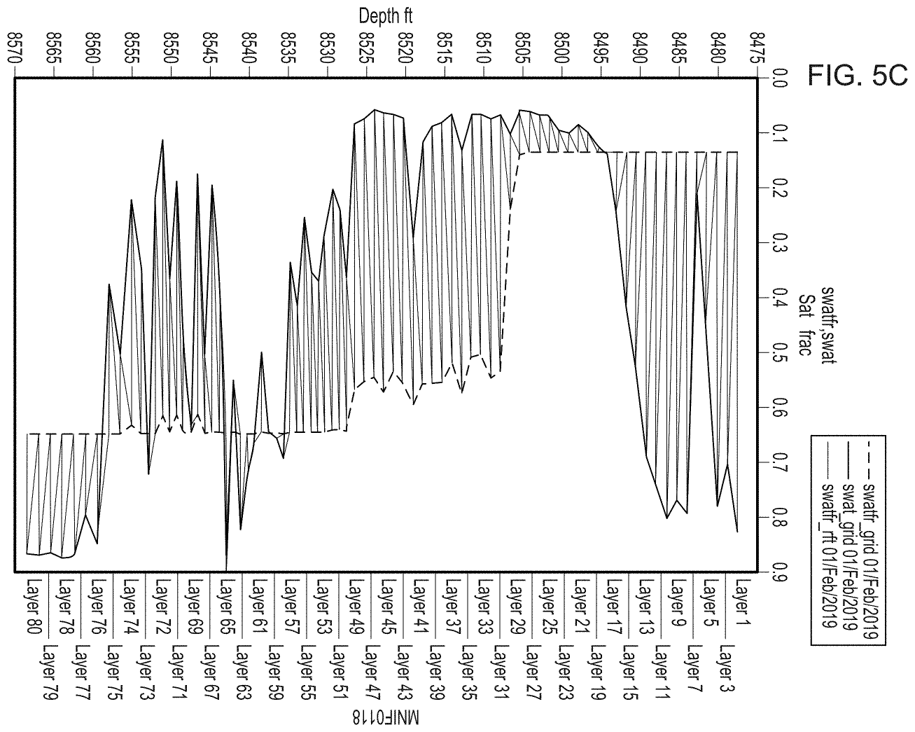

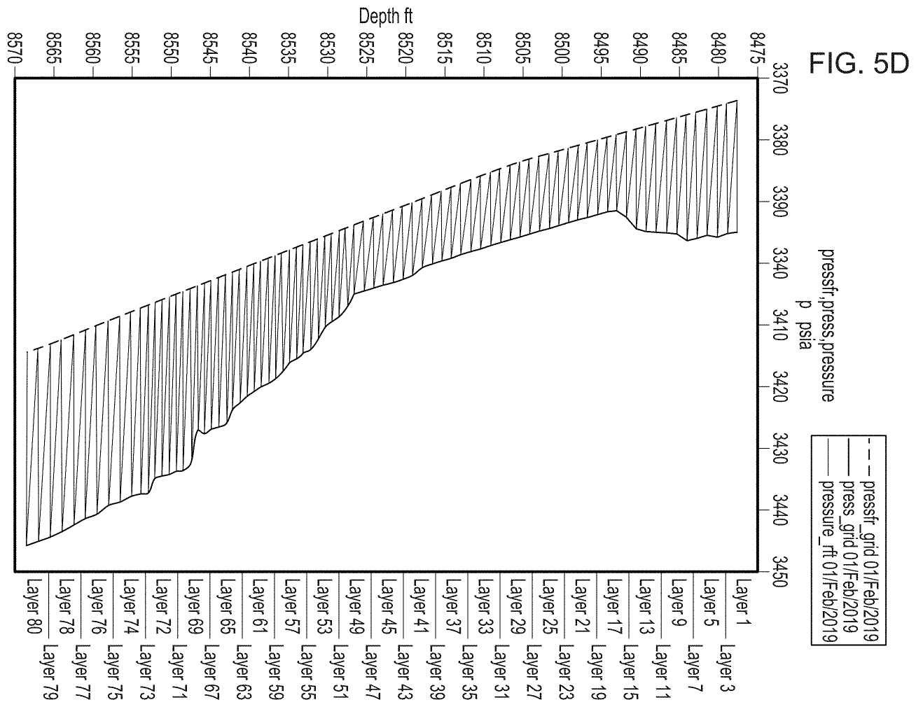

FIGS. 5A-5B illustrate example MDT and Pulsed Neutron Log (PNL) output from numerical simulation, in accordance with one or more implementations. The MDT and PNL output from numerical simulation provides the matrix block pressure and water-saturation results. The simulation does not provide the fracture pressure and saturation. FIGS. 5C-5D illustrate example MDT and Pulsed Neutron Log (PNL) output from numerical simulation, in accordance with one or more implementations. The MDT and PNL outputs from the simulator contain both the matrix and grid results at each depth, thus giving rise to a wiggly output.

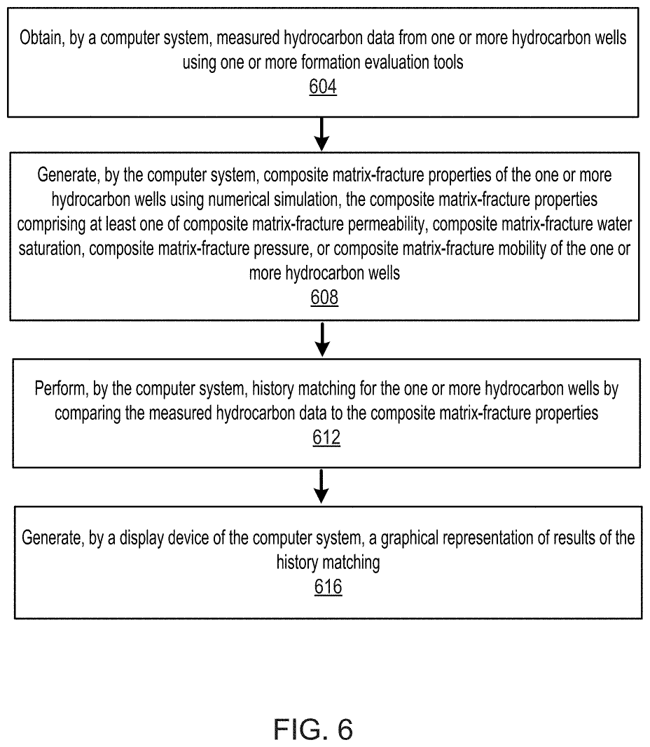

FIG. 6 illustrates a process for determining composite matrix-fracture properties of naturally fractured reservoirs in numerical reservoir simulation, in accordance with one or more implementations. In some implementations, the process is performed by the computer system illustrated and described in more detail with reference to FIG. 18.

In step 604, the computer system obtains measured hydrocarbon data from one or more hydrocarbon wells using one or more formation evaluation tools. The formation evaluation tools include at least a Modular Dynamics Tester (MDT) pressure-mobility probe. In step 608, the computer system generates composite matrix-fracture properties of the one or more hydrocarbon wells using numerical simulation. The composite matrix-fracture properties include at least one of composite matrix-fracture permeability, composite matrix-fracture water saturation, composite matrix-fracture pressure, or composite matrix-fracture mobility of the one or more hydrocarbon wells. In some implementations, the computer system obtains a first grid and a second grid representing the one or more hydrocarbon wells. The first grid includes matrix properties of the one or more hydrocarbon wells and the second grid includes fracture properties of the one or more hydrocarbon wells. The numerical simulation is based on the first grid and the second grid. The first grid and the second grid are illustrated and described in more detail with reference to FIGS. 1, 2A, and 2B.

In some implementations, the computer system uses analytical formulations for determination of the matrix-fracture composite properties in numerical simulation. For example, the composite matrix-fracture permeability is determined as k=k^{f}+k^{m}, wherein k denotes the composite matrix-fracture permeability, k^{f} denotes a fracture permeability, and km denotes a matrix permeability. The properties are used during history matching of naturally fractured reservoirs.

In step 612, the computer system performs history matching for the one or more hydrocarbon wells by comparing the measured hydrocarbon data to the composite matrix-fracture properties. The determined composite matrix-fracture permeability, water saturation, mobility, and pressure in naturally fractured reservoirs are used in comparison to measured data during history matching. In some implementations, the measured hydrocarbon data includes measured Pulsed Neutron Log (PNL) data. The history matching includes comparing the measured PNL data to the composite matrix-fracture water saturation. In some implementations, the measured hydrocarbon data includes measured MDT data. The history matching includes comparing the measured MDT data to the composite matrix-fracture pressure. In some implementations, the measured hydrocarbon data includes measured mobility data. The history matching includes comparing the measured mobility data to the composite matrix-fracture mobility.

In step 616, a display device 1824 of the computer system generates a graphical representation of results of the history matching. The display device 1824 is illustrated and described in more detail with reference to FIG. 18. In some implementations, the computer system calibrates a first transmissivity of a fracture model of the one or more hydrocarbon wells based on a second transmissivity obtained from pressure transient analysis (PTA). The calibrating uses the composite matrix-fracture permeability. The measured hydrocarbon data includes the second transmissivity.

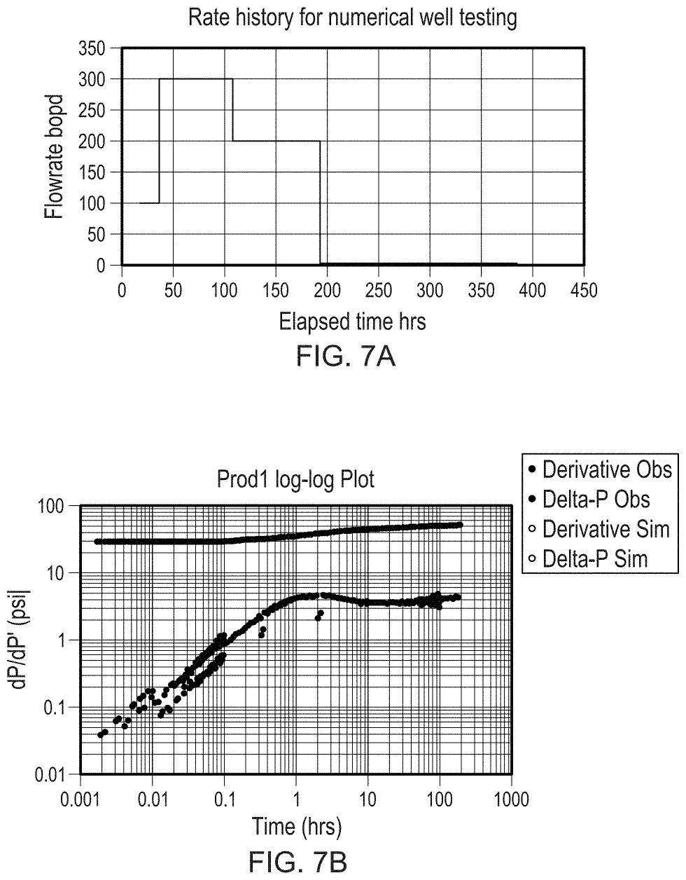

FIG. 7A illustrates a graphical representation of a flow rate against elapsed time, in accordance with one or more implementations. The computer system, illustrated and described in more detail with reference to FIG. 18, determines the composite matrix-fracture permeability using numerical simulation. For example, the computer system uses Darcy's radial flow method in equation (1) as follows.

$$q = \frac{2 π k h Δ P}{μβln ( \frac{{r}_{e}}{{r}_{w}} )} \qquad ( 1 )$$

As described in more detail with reference to FIG. 1, the DPDP representation of natural fractures assumes that both the matrix and the fracture grid dimensions are the same, however, the properties of the two grids are different. Hence, the computer system generates the fracture properties (equation (2)) and matrix properties (equation (3)) as follows.

$$\begin{matrix}{q}_{f} = \frac{2 π {k}^{f} h Δ P}{μβ ln ( \frac{{r}_{e}}{{r}_{w}} )} & ( 2 ) \\ {q}_{m} = \frac{2 π {k}^{m} h Δ P}{μβ ln ( \frac{{r}_{e}}{{r}_{w}} )} & ( 3 )\end{matrix}$$

The total flow-rate at the wellbore, represented in equations (2) and (3) can be determined as a sum of flow through the matrix and flow through the fracture, and represented as in equation (4).

q=q_{f}+qₘ (4)

Here, q denotes the total flow-rate, of denotes the flow through the fracture, and qₘ denotes the flow through the matrix, as illustrated and described in more detail with reference to FIG. 2B. Therefore, the computer system combines equations (2), (3), and (4) to obtain equation (5) as follows.

$$\frac{2 π k h Δ P}{μβ ln ( \frac{{r}_{e}}{{r}_{w}} )} = \frac{2 π {k}^{f} h Δ {P}^{f}}{μβ ln ( \frac{{r}_{e}}{{r}_{w}} )} + \frac{2 π {k}^{m} h Δ {P}^{m}}{μβ ln ( \frac{{r}_{e}}{{r}_{w}} )} \qquad ( 5 )$$

From equation (5), the computer system makes the following definitions.

ΔP=P₀^{*}−P_{wf} (6)

In equation (6), P₀^{*} denotes an average pressure of the composite matrix-fracture system. Similarly, the computer system defines an equation (7) as follows.

ΔP^{f}=P₀^{f}−P_{wf} (7)

In equation (7), ΔP₀^{m} denotes an average pressure of the fracture system. Similarly, the computer system defines an equation (8) as follows.

ΔP^{m}=P₀^{m}−P_{wf} (8)

In equation (8), ΔP₀^{m} denotes an average pressure of the matrix system. Further the value of P_{wf} is the same across both the fracture system and the matrix system.

Permeability is an initial property. Hence, it needs to be calculated only once at the beginning of the numerical simulation. At simulation time zero, there is no flow and the matrix-fracture system is in static pressure equilibrium, as expressed in equation (9) as follows.

P₀^{f}=P₀^{m}=P₀^{*} (9)

As the numerical simulation advances to time-step t1, the same bottom-hole flowing pressure P_{wf} is imposed on both the matrix and fracture systems, as expressed in equation (10) as follows.

ΔP₀^{f}=ΔP₀^{m}=ΔP (10)

In some implementations, the composite matrix-fracture permeability is determined as k=k^{f}+k^{m}. Here, k denotes the composite matrix-fracture permeability, kf denotes a fracture permeability, and km denotes a matrix permeability. Because the same value of ΔP is imposed across the matrix and fracture systems, the expression in equation (5) can be simplified as shown in equation (11) as follows.

k=k^{f}+k^{m} (11)

Here, k denotes the composite matrix-fracture permeability. The value of k is comparable to the interpreted results obtained from PTA. In order to validate equation (11), numerical well-testing was used as shown in FIGS. 7A-&B. A synthetic geo-model with ten layers was created having a homogeneous matrix property: Δx=Δy=100 feet (ft) and Δz=20 ft. The rock and fluid properties associated with FIG. 7A are φ=0.15, k^{m}=10 md, βₒ=1.65, μₒ=0.28, and h=200 ft. Permeability is related to the log-log derivative stabilization “m” by equation (12) as follows.

$$k = \frac{70.6 q β μ}{m * h} \qquad ( 12 )$$

FIG. 7B illustrates a graphical representation of a flow rate against elapsed time, in accordance with one or more implementations. As shown in FIG. 7B, the derivative stabilization “m”=3.3. Further, equation (12) is used to obtain the value k=9.9 md (millidarcy). The original input geo-model permeability was 10 md and the numerical well-testing results lead to 9.9 md. Hence, the numerical well testing can be used to determine the geo-model permeability.

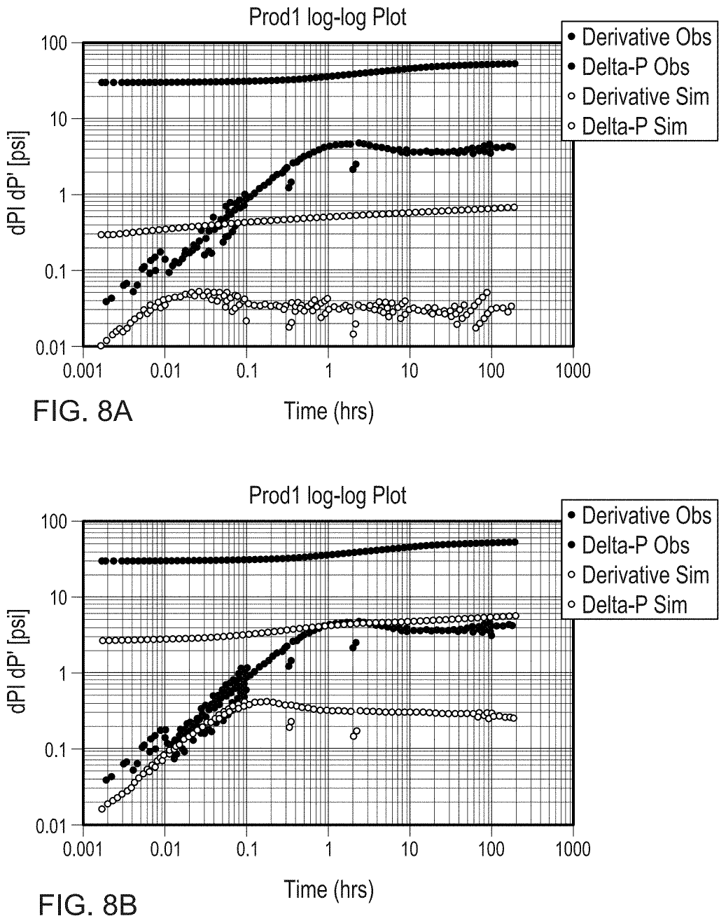

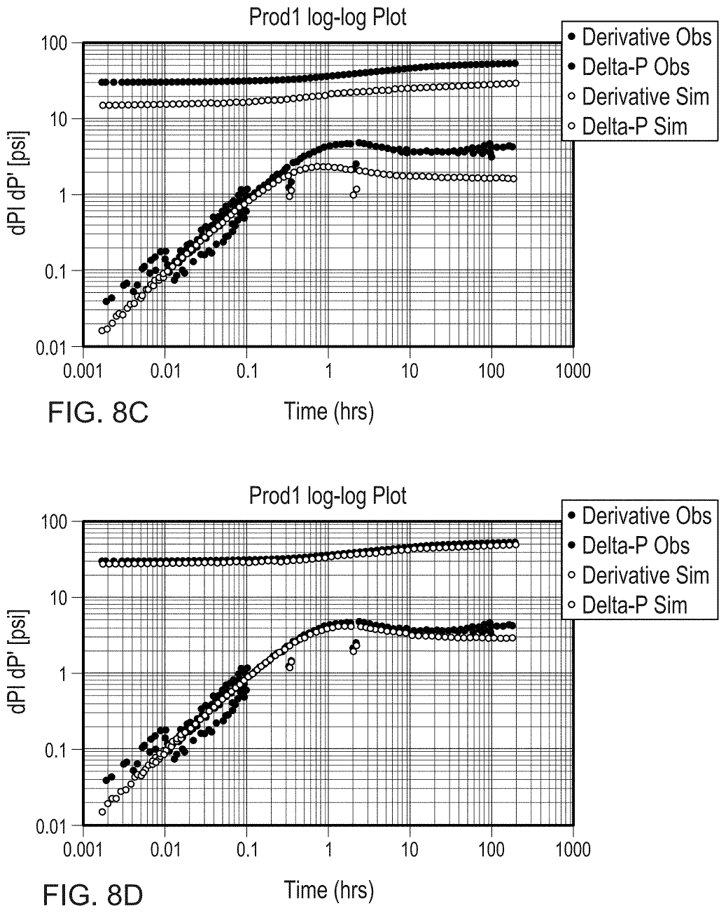

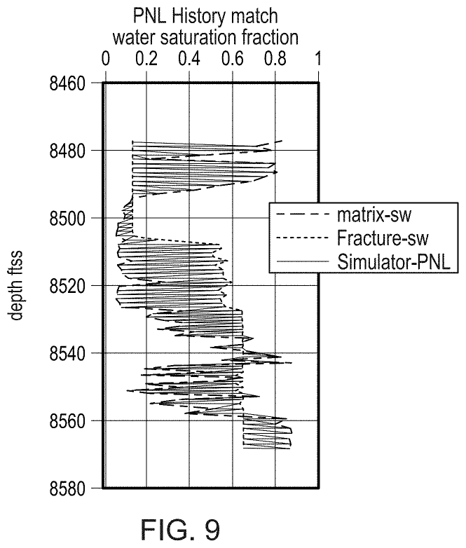

FIG. 8A illustrates an example of numerical well testing for a fracture model, in accordance with one or more implementations. The fracture model associated with FIG. 8A has a value of k^{f}=1000 md. Numerical well testing was conducted using the same rate history as described previously. For the case in FIG. 8A, m=0.032. The use of equation (12) leads to a value of k=1012 md. For the scenario shown in FIG. 8A, the average permeability determined using equation (11) is 10+1000=1010 md. Hence, equation (11) can be used to predict the composite matrix-fracture permeability determined using PTA.

FIG. 8B illustrates an example of numerical well testing for a fracture model, in accordance with one or more implementations. The fracture model associated with FIG. 8A has a value of k^{f}=100 md. Numerical well testing was conducted using the same rate history as described previously. For the case in FIG. 8B, m=0.3. The use of equation (12) leads to a value of k=109 md. For the scenario shown in FIG. 8A, the average permeability determined using equation (11) is 10+100=110 md. Hence, equation (11) can be used to predict the composite matrix-fracture permeability determined using PTA.

FIG. 8C illustrates an example of numerical well testing for a fracture model, in accordance with one or more implementations. The fracture model associated with FIG. 8C has a value of kf=10 md. Numerical well testing was conducted using the same rate history as described previously. For the case in FIG. 8C, m=1.6. The use of equation (12) leads to a value of k=20.3 md. For the scenario shown in FIG. 8C, the average permeability determined using equation (11) is 10+10=20 md. Hence, equation (11) can be used to predict the composite matrix-fracture permeability determined using PTA.

FIG. 8D illustrates an example of numerical well testing for a fracture model, in accordance with one or more implementations. The fracture model associated with FIG. 8D has a value of k^{f}=1 md. Numerical well testing was conducted using the same rate history as described previously. For the case in FIG. 8D, m=3. The use of equation (12) leads to a value of k=10.9 md. For the scenario shown in FIG. 8D, the average permeability determined using equation (11) is 10+1=11 md. Hence, equation (11) can be used to predict the composite matrix-fracture permeability determined using PTA. The experiments illustrated in FIGS. 8A-8D demonstrate that while the well test interpretation leads to a combined permeability of the fracture and matrix systems, the computer system can use equation (11) to provide equivalent determinations that can be used to estimate the composite matrix-fracture permeability in numerical simulation.

In some implementations, the computer system, illustrated and described in more detail with reference to FIG. 18 determines a composite matrix-fracture pressure using numerical simulation. The computer system uses two equations as follows. A first equation is based on the compressibility equation and applicable when a hydrocarbon well is shut-in. A second equation is based on Darcy's equation and applicable when the well is flowing. For example, the computer system begins at the compressibility equation, which relates the pressure depletion within an initial volume to a cumulative production as shown in equations (13)-(14).

Δv=cVΔP (13)

ΔP=P₀^{*}−P₁^{*} (14)

Here, equation (14) is used to determine a change in the composite matrix-fracture pressure between the beginning and end of a time-step.

An equivalent expression can be determined independently for the matrix and the fracture networks as follows. A fracture aperture (opening) is estimated from geo-mechanical studies. The fracture aperture is converted into an average fracture porosity, which is the parameter used by numerical simulators. The implementations disclosed to determine reservoir oil-in-place assumes that the storage resides in the matrix while the fracture serves for transport. Therefore, in order to satisfy numerical simulation requirements for the fracture porosity while maintaining consistency with geological volume estimation, the matrix volume is reduced by the volume attributed to fracture due to its porosity. Therefore, if the fracture porosity is φ^{f}, the matrix porosity is determined by expression (15) as follows.

φ^{m}−φ^{f} (15)

The computer system determines compressibility expressions for the fracture and matrix systems as follows in equations (17) and (18).

Δv^{f}=cV^{f}ΔP^{f} (17)

Δv^{m}=c(V^{m}−V^{f})ΔP^{m} (18)

The total production is the sum of production from the fracture and production from the matrix, expressed as follows in equation (19).

Δv=Δv^{f}+Δv^{m} (19)

Thus, the computer system, from equation (19), can determine equations (20) and (21) as follows.

$$\begin{matrix}c V Δ P = c {V}^{f} Δ {P}^{f} + c ( {V}^{m} - {V}^{f} ) Δ {P}^{m} & ( 20 ) \\ Δ P = \frac{{V}^{f} Δ {P}^{f}}{V} + \frac{( {V}^{m} - {V}^{f} ) Δ {P}^{m}}{V} & ( 21 )\end{matrix}$$

In some implementations, generating the composite matrix-fracture properties includes obtaining, by the computer system, a first grid and a second grid representing the one or more hydrocarbon wells. The first grid includes matrix properties of the one or more hydrocarbon wells and the second grid includes fracture properties of the one or more hydrocarbon wells. The numerical simulation is based on the first grid and the second grid. For each grid block, as illustrated and described with reference to FIG. 1, the computer system determines equations (22), (23), and (24) as follows.

V^{f}=Δx*Δy*h*φf (22)

V^{m}=Δx*Δy*h*(φ^{m}−φ^{f}) (23)

V=Δx*Δy*h*φ^{m} (24)

Therefore, the computer system transforms equation (21) into equation (25) as follows.

$$Δ P = \frac{Δ {P}^{f} {φ}^{f}}{{φ}^{m}} + Δ {P}^{m} \qquad ( 25 )$$

Thus, the composite matrix-fracture pressure change during any time-step is determined as the matrix pressure change in equation (26) as follows.

ΔP^{m}=P₀^{*}−P₁^{m} (26)

The expression in equation (26) is summed with the product of the fracture pressure change (see equation (27)) and the fracture-matrix porosity ratio. The composite matrix-fracture pressure change is larger than that of the grid only and not as large as that of the fracture only.

ΔP^{f}=P₀^{*}−P₁^{f} (27)

The computer system uses equation (14) to obtain the composite matrix-fracture pressure at the end of the current time-step as shown in equation (28) as follows.

P₁^{*}=P₀^{*}−ΔP (28)

The composite matrix-fracture pressure at the end of a time-step is the composite matrix-fracture pressure at the start of the time-step less the composite matrix-fracture ΔP determined using equation (25). The value of P₁^{*} determined at the end of the time-step n is used as the P₀^{*} for the start of the time-step n+1. Returning to the equation (5) obtained from Darcy's equation and expressing the total flow-rate into the wellbore as the sum of the flow-rate through the fracture and the flow-rate through the matrix, the computer system obtains equation (29) as follows.

$$\frac{2 π k h Δ P}{μβ ln ( \frac{{r}_{e}}{{r}_{w}} )} = \frac{2 π {k}^{f} h Δ {P}^{f}}{μβ ln ( \frac{{r}_{e}}{{r}_{w}} )} + \frac{2 π {k}^{m} h Δ {P}^{m}}{μβ ln ( \frac{{r}_{e}}{{r}_{w}} )} \qquad ( 29 )$$

In accordance with equation (29), the computer system determines equations (30), (31), and (32) as follows.

ΔP=P₀^{*}−P_{wf} (30)

ΔP^{f}=P₀^{f}−P_{wf} (31)

ΔP^{m}=P₀^{m}−P_{wf} (32)

At simulation time-step t0, the values are determined as P₀^{f}=P₀^{m} because of the initial static equilibrium. However, as simulation advances, the pressure in the matrix and the fracture at the start of any time-step can be different. The computer system determines an equivalent single value of the matrix-fracture pressure for history-matching purposes. Hence, the computer system modifies equation (29) as equations (33) and (34) as follows.

$$\begin{matrix}k Δ P = {k}^{f} Δ {P}^{f} + {k}^{m} Δ {P}^{m} & ( 33 ) \\ Δ P = \frac{{k}^{f} Δ {P}^{f} + {k}^{m} Δ {P}^{m}}{k} & ( 34 )\end{matrix}$$

Here, k denotes the composite matrix-fracture permeability as determined by equation (11). The composite matrix-fracture pressure can be obtained using equation (35) as follows.

P₀^{*}=ΔP+P_{wf} (35)

Numerical simulation reports the value of P_{wf} for each gridblock as the connection-pressure.

In some implementations, the computer system determines a composite matrix-fracture water-saturation using numerical simulation. At a time-step, the volume of water contained within a fracture grid is determined by equation (36) as follows.

v_{w}^{f}=Δx*Δy*Δz*φ^{f}*s_{w}^{f} (36)

The volume of water contained within a matrix grid is determined by equation (37) as follows.

v_{w}^{m}=Δx*Δy*Δz*(φ^{m}−φ^{f})*s_{w}^{m} (37)

The matrix volume is reduced by the amount of volume allocated to the fracture. The total volume of water in the matrix-fracture system is therefore determined using equations (36) and (37) as shown in equation (38).

v_{w}^{T}=Δx*Δy*Δz*((φ^{f}*s_{w}^{f})+(φ^{m}−φ^{f})*s_{w}^{m}) (38)

The total pore volume of grid-block is given by equation (39).

vₚ^{T}=Δx*Δy*Δz*φ^{m} (39)

Therefore, the composite matrix-fracture water saturation is given by equations (40), (41), and (42).

$$\begin{matrix}{s}_{w} = \frac{{v}_{w}^{T}}{{v}_{p}^{T}} = \frac{( {φ}^{f} * {s}_{w}^{f} ) + ( {φ}^{m} - {φ}^{f} ) * {s}_{w}^{m}}{{φ}^{m}} & ( 40 ) \\ {s}_{w} = \frac{{φ}^{f} ( {s}_{w}^{f} - {s}_{w}^{m} )}{{φ}^{m}} + \frac{{φ}^{m} {s}_{w}^{m}}{{φ}^{m}} & ( 41 ) \\ {s}_{w} = \frac{{φ}^{f} ( {s}_{w}^{f} - {s}_{w}^{m} )}{{φ}^{m}} + {s}_{w}^{m} & ( 42 )\end{matrix}$$

FIG. 9 illustrates example PNL history matching, in accordance with one or more implementations. Natural fractures are a component part of most carbonate reservoirs. Typically, a carbonate reservoir is fractured unless otherwise stated. In some implementations, the computer system obtains measured hydrocarbon data from one or more hydrocarbon wells using one or more formation evaluation tools. The formation evaluation tools include at least a Modular Dynamics Tester (MDT) pressure-mobility probe. The implementations disclosed herein enable history matching PTA-kh, MDT-pressure, MDT-mobility, and PNL saturation measurements in fractured reservoirs. The implementations provide relevant numerical outputs to be compared with the measured data. PNL tools track evolution of the water saturation in the near well-bore areas. This information is used to detect or track an advancing water-oil contact or to track the zones where water is arriving to the well. For a well that is producing at a high water-cut, these tools can detect if there are areas of bypassed oil that could warrant a re-perforation or a side-track.

The PNL tools have a vertical resolution of about 5 inches. FIG. 9 shows a simulated matrix-grid saturation, fracture-grid saturation, and the simulator water-saturation log output. While the simulator outputs the grid and fracture water saturation values independently, other simulators can investigate both matrix and fracture results at each depth, thereby resulting in a wiggly plot. The implementations enable history-matching four-dimensional (4D) saturation in naturally fractured reservoirs by generating a composite matrix-fracture water saturation that can be compared to measured PNL data.

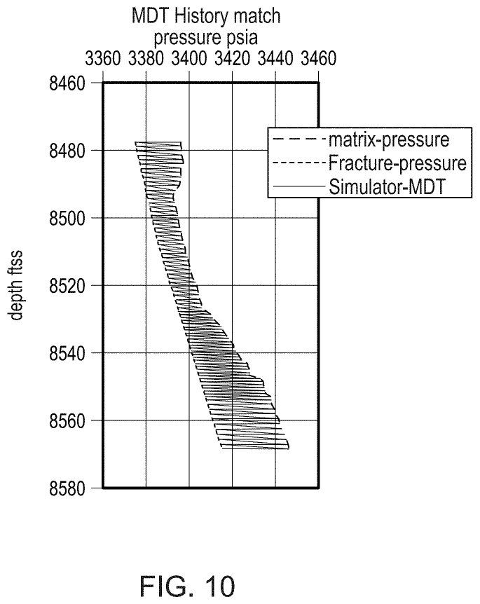

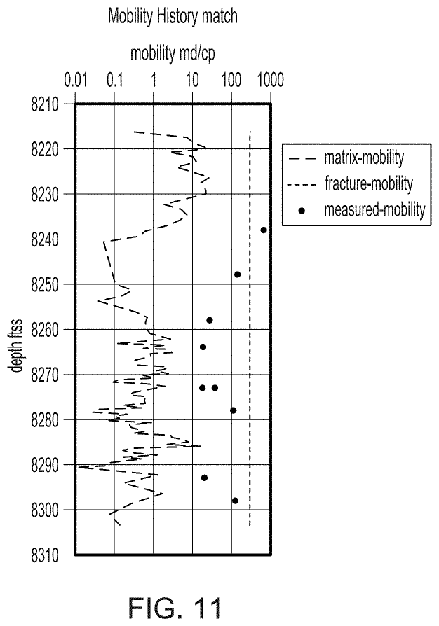

FIG. 10 illustrates example MDT history matching, in accordance with one or more implementations. In some implementations, the computer system performs history matching for the one or more hydrocarbon wells by comparing the measured hydrocarbon data to the composite matrix-fracture properties. MDT tools are used to measure reservoir pressure at various depths during drilling. The pressure versus depth information can be used to detect changes in the reservoir fluid gradient and thus infer the reservoir fluid contacts. The data also provides information about vertical communication barriers within the reservoir. The MDT tool include a three square inch surface area probe (as illustrated and described in more detail with reference to FIG. 2C) through which flow is initiated before subsequent shut-in and corresponding pressure build-up. From the size of the tool and the measurement procedure, the measured pressure does not discriminate between pressure in the fracture network and pressure in the matrix blocks. A first simulator used outputs pressures in the matrix and pressures in the fracture independently, while a second simulator outputs the two pressure values for each depth (fracture pressure and grid pressure) resulting in the wiggly plot shown with reference to FIGS. 5A and 5B. To history-match the measured MDT pressures, a composite matrix-fracture pressure is required as disclosed herein.

FIG. 11 illustrates example mobility history matching, in accordance with one or more implementations. In some implementations, the measured hydrocarbon data includes measured mobility data. The history matching includes comparing the measured mobility data to the composite matrix-fracture mobility. A display device of the computer system generates a graphical representation of results of the history matching. In some implementations, the mobility is measured while conducting an MDT survey. The mobility measurements include initiating flow through a three square inch probe followed with a build-up. The measured pressure responses during the flow and build-up are interpreted for drawdown-mobility or build-up mobility. From the manner the test is conducted, the resulting data does not distinguish between mobility of fracture and that of matrix. The resulting mobility interpretation captures the mobility of the composite matrix-fracture system. For example, the mobility can be determines as

$$\frac{K {k}_{r}}{μ} .$$

For a single-phase flow situation, the determination reduces to K/μ. The numerical simulators output the matrix permeability and fracture permeability for each grid block. Hence, the mobility is determined using either the matrix permeability or the fracture permeability as shown in FIG. 11. The appropriate parameter for history matching of mobility data in naturally fractured reservoirs is the composite matrix-fracture mobility.

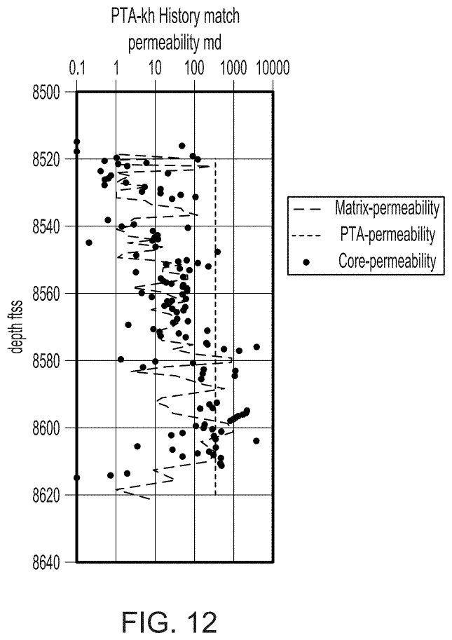

FIG. 12 illustrates example PTA-kh history matching, in accordance with one or more implementations. Natural fractures provide additional well productivity beyond what the matrix properties can provide. The fractures constitute small apertures but high permeability pathways within otherwise predominantly tight reservoir rocks. A measure of a well's productive capacity is the product of connected permeability and height (kh). The average connected kh is measured through Pressure Transient Analysis (PTA). From well-testing, kh is interpreted from the derivative plot stabilization of a log-log diagnostic plot using

$$kh = \frac{70.6 q β μ}{m} .$$

In a naturally fractured reservoir, the stabilization of the derivative plot is indicative of the combined kh of the matrix and fracture systems.

In some implementations, the computer system calibrates a first transmissivity of a fracture model of the one or more hydrocarbon wells based on a second transmissivity obtained from pressure transient analysis (PTA). The calibrating uses the composite matrix-fracture permeability. The measured hydrocarbon data includes the second transmissivity. The PTA-kh parameter is history matched in the simulation model in order to calibrate the properties of the reservoir. FIG. 12 shows that the simulation model permeability is adequately matching the measured core permeability data. However, the PTA test conducted on this well indicates an average kh of 35,000 md-ft (h=100 ft and k=350 md). In the implementations disclosed herein, analytical methods are used to determine the composite matrix-fracture parameters to be compared to measured values during history matching. Both the tool configuration and the process of acquiring the measured data are used.

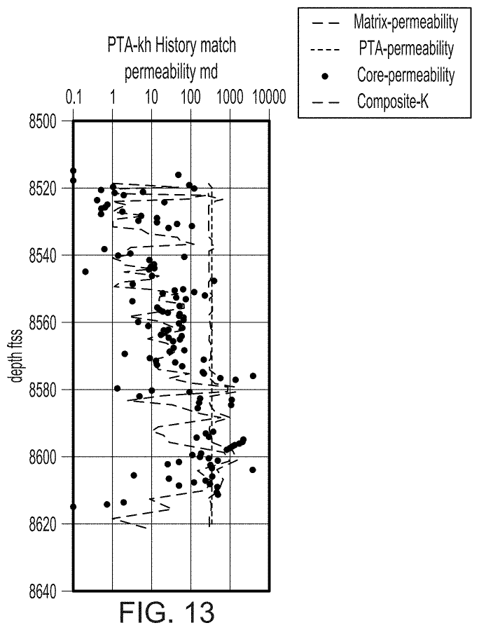

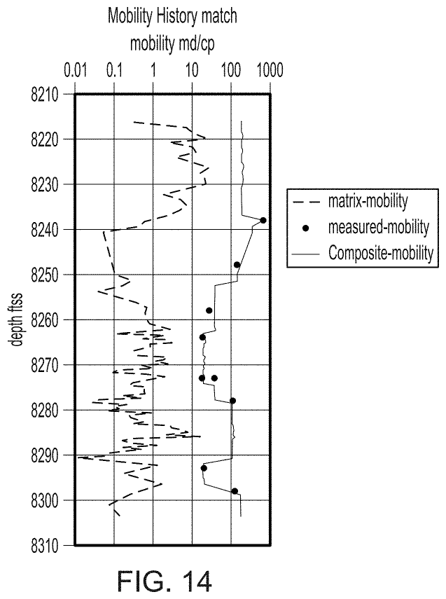

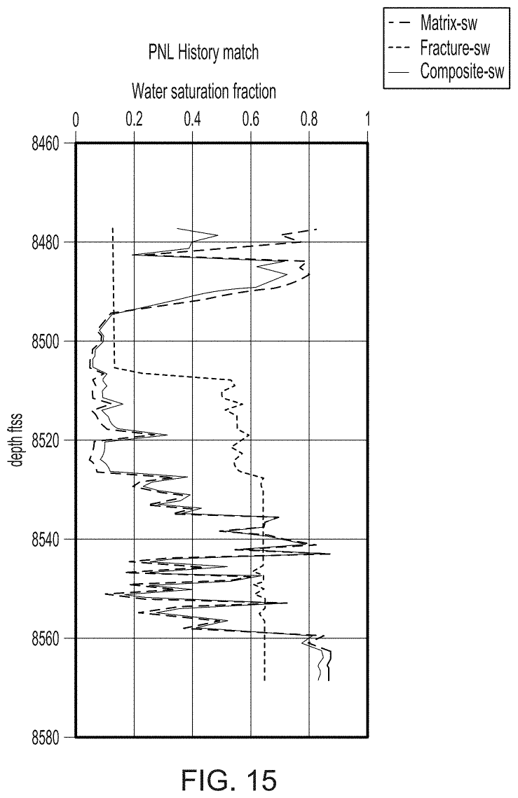

FIG. 13 illustrates example PTA-kh history matching, in accordance with one or more implementations. For a fracture permeability of 300 md defined in the reservoir, the matrix-fracture composite permeability is as shown in FIG. 13. The numerical composite-K is directly compared to the measured PTA-kh. The model permeability matches the measured cored data. Hence, a mismatch with the PTA-kh is history-matched by adjusting the permeability of fractures. The K-composite denotes the numerical results to be compared with the PTA-kh. FIG. 14 illustrates example mobility history matching, in accordance with one or more implementations. A fracture model is introduced into the reservoir and a numerical composite mobility is determined to be compared with the measured data. FIG. 15 illustrates example PNL history matching, in accordance with one or more implementations. In some implementations, the measured hydrocarbon data includes measured Pulsed Neutron Log (PNL) data. The history matching includes comparing the measured PNL data to the composite matrix-fracture water saturation. As shown, the composite-sw is compared to the measured PNL data and not to the matrix-sw or the fracture-sw.

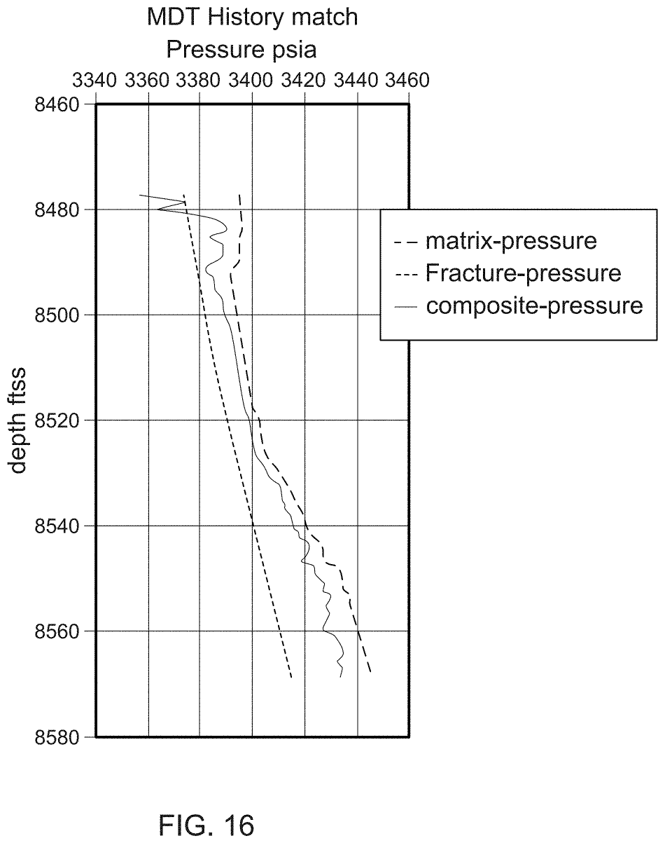

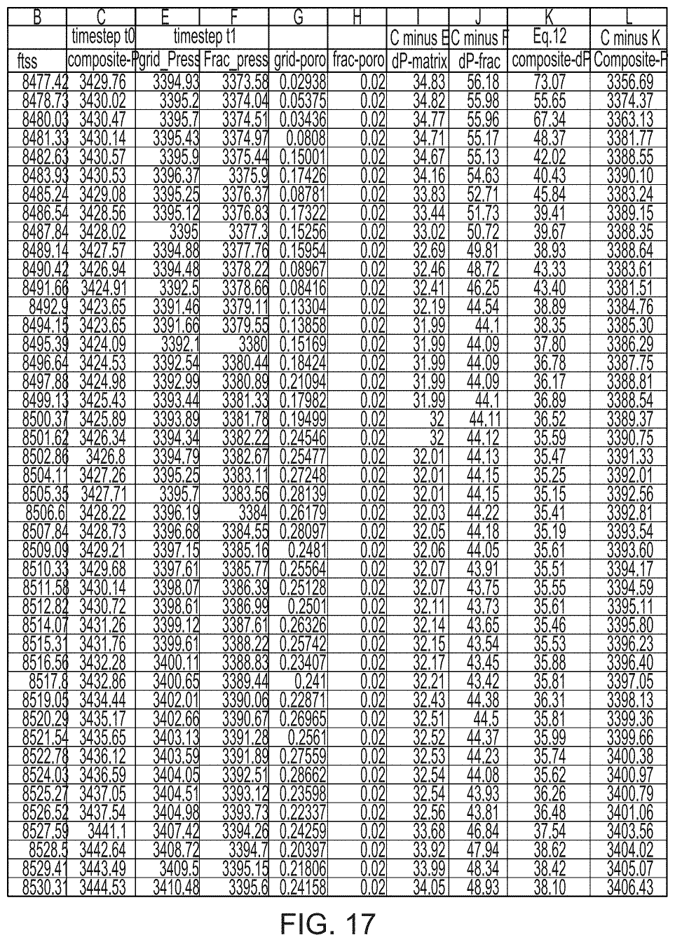

FIG. 16 illustrates example MDT history matching, in accordance with one or more implementations. In some implementations, the measured hydrocarbon data includes measured MDT data. The history matching includes comparing the measured MDT data to the composite matrix-fracture pressure. To determine the composite pressure for MDT matching at time t1, the composite pressure for t0 is used. This is either the initial reservoir pressure if the time t1 is the first simulation time-step or the already calculated composite pressure prior to the time-step of interest. FIG. 17 illustrates experimental results for determining composite matrix-fracture properties of naturally fractured reservoirs in numerical reservoir simulation, in accordance with one or more implementations. The equation (28) is used because the well is shut in at the period of determination. For a flowing period, equation (35) is used. For each grid depth, equations (43) and (44) are determined.

P₁^{*}=P₀^{*}−ΔP (43)

P₀^{*}=ΔP+P_{wf} (44)

The implementations disclosed herein thus enable history matching of the available PTA-kh, PNL saturation, MDT mobility, and MDT pressure in naturally fractured reservoirs. Further, composite matrix-fracture properties are determined in numerical simulation. History matching, the process of comparing simulator results to observed data, is performed. Simulator inputs are modified if necessary until the measured data is matched. The implementations enable the numerical equivalent matrix-fracture properties to be compared to measured data in naturally fractured reservoirs.

FIG. 18 illustrates an example computer system, in accordance with one or more implementations. In the example implementation, the computer system is a special purpose computing device. The special-purpose computing device is hard-wired or includes digital electronic devices such as one or more application-specific integrated circuits (ASICs) or field programmable gate arrays (FPGAs) that are persistently programmed to perform the techniques herein, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system includes a bus 1802 or other communication mechanism for communicating information, and one or more computer hardware processors 1808 coupled with the bus 1802 for processing information. The hardware processors 1808 are, for example, general-purpose microprocessors. The computer system also includes a main memory 1806, such as a random-access memory (RAM) or other dynamic storage device, coupled to the bus 1802 for storing information and instructions to be executed by processors 1808. In one implementation, the main memory 1806 is used for storing temporary variables or other intermediate information during execution of instructions to be executed by the processors 1808. Such instructions, when stored in non-transitory storage media accessible to the processors 1808, render the computer system into a special-purpose machine that is customized to perform the operations specified in the instructions.

In an embodiment, the computer system further includes a read only memory (ROM) 1810 or other static storage device coupled to the bus 1802 for storing static information and instructions for the processors 1808. A storage device 1812, such as a magnetic disk, optical disk, solid-state drive, or three-dimensional cross point memory is provided and coupled to the bus 1802 for storing information and instructions.

In an embodiment, the computer system is coupled via the bus 1802 to a display 1824, such as a cathode ray tube (CRT), a liquid crystal display (LCD), plasma display, light emitting diode (LED) display, or an organic light emitting diode (OLED) display for displaying information to a computer user. An input device 1814, including alphanumeric and other keys, is coupled to bus 1802 for communicating information and command selections to the processors 1808. Another type of user input device is a cursor controller 1816, such as a mouse, a trackball, a touch-enabled display, or cursor direction keys for communicating direction information and command selections to the processors 1808 and for controlling cursor movement on the display 1824. This input device typically has two degrees of freedom in two axes, a first axis (e.g., x-axis) and a second axis (e.g., y-axis), that allows the device to specify positions in a plane.

According to one embodiment, the techniques herein are performed by the computer system in response to the processors 1808 executing one or more sequences of one or more instructions contained in the main memory 1806. Such instructions are read into the main memory 1806 from another storage medium, such as the storage device 1812. Execution of the sequences of instructions contained in the main memory 1806 causes the processors 1808 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 1812. Volatile media includes dynamic memory, such as the main memory 1806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but can be used in conjunction with transmission media. Transmission media participates in transferring information between storage media. For example, transmission media includes coaxial cables, copper wire and fiber optics, including the wires that include the bus 1802. Transmission media can also take the form of acoustic or light waves, such as those generated during radio-wave and infrared data communications.

In an embodiment, various forms of media are involved in carrying one or more sequences of one or more instructions to the processors 1808 for execution. For example, the instructions are initially carried on a magnetic disk or solid-state drive of a remote computer. The remote computer loads the instructions into its dynamic memory and send the instructions over a telephone line using a modem. A modem local to the computer system receives the data on the telephone line and use an infrared transmitter to convert the data to an infrared signal. An infrared detector receives the data carried in the infrared signal and appropriate circuitry places the data on the bus 1802. The bus 1802 carries the data to the main memory 1806, from which processors 1808 retrieves and executes the instructions. The instructions received by the main memory 1806 can optionally be stored on the storage device 1812 either before or after execution by processors 1808.

The computer system also includes a communication interface 1818 coupled to the bus 1802. The communication interface 1818 provides a two-way data communication coupling to a network link 1820 that is connected to a local network 1822. For example, the communication interface 1818 is an integrated service digital network (ISDN) card, cable modem, satellite modem, or a modem to provide a data communication connection to a corresponding type of telephone line. As another example, the communication interface 1818 is a local area network (LAN) card to provide a data communication connection to a compatible LAN. In some implementations, wireless links are also implemented. In any such implementation, the communication interface 1818 sends and receives electrical, electromagnetic, or optical signals that carry digital data streams representing various types of information.

The network link 1820 typically provides data communication through one or more networks to other data devices. For example, the network link 1820 provides a connection through the local network 1822 to a host computer 1824 or to a cloud data center or equipment operated by an Internet Service Provider (ISP) 1826. The ISP 1826 in turn provides data communication services through the world-wide packet data communication network now commonly referred to as the “Internet” 1828. The local network 1822 and Internet 1828 both use electrical, electromagnetic or optical signals that carry digital data streams. The signals through the various networks and the signals on the network link 1820 and through the communication interface 1818, which carry the digital data to and from the computer system, are example forms of transmission media.

The computer system sends messages and receives data, including program code, through the network(s), the network link 1820, and the communication interface 1818. In an embodiment, the computer system receives code for processing. The received code is executed by the processors 1808 as it is received, and/or stored in storage device 1812, or other non-volatile storage for later execution.

What is claimed is:

1. A method comprising:
obtaining, by a computer system, measured hydrocarbon data from one or more hydrocarbon wells using one or more formation evaluation tools;
generating, by the computer system, composite matrix-fracture properties of the one or more hydrocarbon wells using numerical simulation, the composite matrix-fracture properties comprising at least one of composite matrix-fracture permeability, composite matrix-fracture water saturation, composite matrix-fracture pressure, or composite matrix-fracture mobility of the one or more hydrocarbon wells;
performing, by the computer system, history matching for the one or more hydrocarbon wells by comparing the measured hydrocarbon data to the composite matrix-fracture properties; and
generating, by a display device of the computer system, a graphical representation of results of the history matching.

2. The method of claim 1, wherein generating the composite matrix-fracture properties comprises obtaining, by the computer system, a first grid and a second grid representing the one or more hydrocarbon wells, the first grid comprising matrix properties of the one or more hydrocarbon wells and the second grid comprising fracture properties of the one or more hydrocarbon wells, wherein the numerical simulation is based on the first grid and the second grid.

3. The method of claim 1, wherein one or more formation evaluation tools comprise at least a Modular Dynamics Tester (MDT) pressure-mobility probe.

4. The method of claim 1, further comprising calibrating, by the computer system, a first transmissivity of a fracture model of the one or more hydrocarbon wells based on a second transmissivity obtained from pressure transient analysis (PTA), the calibrating using the composite matrix-fracture permeability, wherein the measured hydrocarbon data comprises the second transmissivity.

5. The method of claim 1, wherein the measured hydrocarbon data comprises measured Pulsed Neutron Log (PNL) data, and wherein the history matching comprises comparing the measured PNL data to the composite matrix-fracture water saturation.

6. The method of claim 1, wherein the measured hydrocarbon data comprises measured MDT data, and wherein the history matching comprises comparing the measured MDT data to the composite matrix-fracture pressure.

7. The method of claim 1, wherein the measured hydrocarbon data comprises measured mobility data, and wherein the history matching comprises comparing the measured mobility data to the composite matrix-fracture mobility.

8. A non-transitory computer-readable storage medium storing instructions executable by one or more computer processors, the instructions when executed by the one or more computer processors cause the one or more computer processors to:
obtain measured hydrocarbon data from one or more hydrocarbon wells using one or more formation evaluation tools;
generate composite matrix-fracture properties of the one or more hydrocarbon wells using numerical simulation, the composite matrix-fracture properties comprising at least one of composite matrix-fracture permeability, composite matrix-fracture water saturation, composite matrix-fracture pressure, or composite matrix-fracture mobility of the one or more hydrocarbon wells;
perform history matching for the one or more hydrocarbon wells by comparing the measured hydrocarbon data to the composite matrix-fracture properties; and
generate, by a display device of the computer system, a graphical representation of results of the history matching.

9. The non-transitory computer-readable storage medium of claim 8, wherein generating the composite matrix-fracture properties comprises obtaining a first grid and a second grid representing the one or more hydrocarbon wells, the first grid comprising matrix properties of the one or more hydrocarbon wells and the second grid comprising fracture properties of the one or more hydrocarbon wells, wherein the numerical simulation is based on the first grid and the second grid.

10. The non-transitory computer-readable storage medium of claim 8, wherein the one or more formation evaluation tools comprise at least a Modular Dynamics Tester (MDT) pressure-mobility probe.

11. The non-transitory computer-readable storage medium of claim 8, wherein the instructions further cause the one or more computer processors to calibrate a first transmissivity of a fracture model of the one or more hydrocarbon wells based on a second transmissivity obtained from pressure transient analysis (PTA), the calibrating using the composite matrix-fracture permeability, wherein the measured hydrocarbon data comprises the second transmissivity.

12. The non-transitory computer-readable storage medium of claim 8, wherein the measured hydrocarbon data comprises measured Pulsed Neutron Log (PNL) data, and wherein the history matching comprises comparing the measured PNL data to the composite matrix-fracture water saturation.

13. The non-transitory computer-readable storage medium of claim 8, wherein the measured hydrocarbon data comprises measured MDT data, and wherein the history matching comprises comparing the measured MDT data to the composite matrix-fracture pressure.

14. The non-transitory computer-readable storage medium of claim 8, wherein the measured hydrocarbon data comprises measured mobility data, and wherein the history matching comprises comparing the measured mobility data to the composite matrix-fracture mobility.

15. A computer system comprising:
one or more computer processors; and
a non-transitory computer-readable storage medium storing instructions executable by the one or more computer processors, the instructions when executed by the one or more computer processors cause the one or more computer processors to:
obtain measured hydrocarbon data from one or more hydrocarbon wells using one or more formation evaluation tools;
generate composite matrix-fracture properties of the one or more hydrocarbon wells using numerical simulation, the composite matrix-fracture properties comprising at least one of composite matrix-fracture permeability, composite matrix-fracture water saturation, composite matrix-fracture pressure, or composite matrix-fracture mobility of the one or more hydrocarbon wells;
perform history matching for the one or more hydrocarbon wells by comparing the measured hydrocarbon data to the composite matrix-fracture properties; and
generate, by a display device of the computer system, a graphical representation of results of the history matching.

16. The computer system of claim 15, wherein generating the composite matrix-fracture properties comprises obtaining a first grid and a second grid representing the one or more hydrocarbon wells, the first grid comprising matrix properties of the one or more hydrocarbon wells and the second grid comprising fracture properties of the one or more hydrocarbon wells, wherein the numerical simulation is based on the first grid and the second grid.

17. The computer system of claim 15, wherein the one or more formation evaluation tools comprise at least a Modular Dynamics Tester (MDT) pressure-mobility probe.

18. The computer system of claim 15, wherein the instructions further cause the one or more computer processors to calibrate a first transmissivity of a fracture model of the one or more hydrocarbon wells based on a second transmissivity obtained from pressure transient analysis (PTA), the calibrating using the composite matrix-fracture permeability, wherein the measured hydrocarbon data comprises the second transmissivity.

19. The computer system of claim 15, wherein the measured hydrocarbon data comprises measured Pulsed Neutron Log (PNL) data, and wherein the history matching comprises comparing the measured PNL data to the composite matrix-fracture water saturation.

20. The computer system of claim 15, wherein the measured hydrocarbon data comprises measured MDT data, and wherein the history matching comprises comparing the measured MDT data to the composite matrix-fracture pressure.
